(19) United States
(12) Patent Application Publication
(10) Pub. No.: US 2008/0181128 A1
(43) Pub. Date: Jul. 31, 2008

(54) EFFICIENT MEAN SQUARE ERROR (MSE) CALCULATION FOR LATTICE ELEMENTS

(75) Inventors: David L. MILLINER, New Orleans, LA (US); Anuj BATRA, Dallas, TX (US); Srinath HOSUR, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/022,663

(22) Filed: Jan. 30, 2008

Related U.S. Application Data
(60) Provisional application No. 60/887,274, filed on Jan. 30, 2007.

(51) Int. Cl. H04J 3/14

(52) U.S. Cl. 370/252

(57) ABSTRACT

In at least some embodiments, a wireless communication system includes a transmitter that transmits a signal over a communication channel. The system also includes a receiver that receives the signal as an output of the communication channel. The receiver selects a first element of a lattice and calculates a Mean-Squared Error (MSE) value for a second element of the lattice based on a difference between the second element and the first element.

### CROSS-REFERENCE TO RELATED APPLICATIONS

This application is a non-provisional application claiming priority to U.S. Pat. App. Ser. No. 60/887,274, entitled “Efficient Mean Square Error (MSE) Computation Exploiting Lattice Structures”, filed on Jan. 30, 2007. The above-referenced application is incorporated herein by reference.

### FIELD OF THE INVENTION

The present disclosure is directed to communication systems, and more particularly, but not by way of limitation, to lattice-reduction-aided (LR-aided) communication systems.

### BACKGROUND

When using linear transformation in communication systems a typical operation is an equalization step. For example, the zero forcing equalizer takes the channel matrix H and inverts it in order to perform detection. Other equalizers include the minimum mean square error equalizer and successive interference cancellation. All of these equalizers can be combined with other processing such as lattice-reduction in order to perform detection. Efficiently enumerating Mean-Squared Error (MSE) values over a lattice would be useful in the context of lattice-reduction.

### SUMMARY

In at least some embodiments, a wireless communication system comprises a transmitter that transmits a signal over a communication channel. The system also comprises a receiver that receives the signal as an output of the communication channel. The receiver selects a first element of a lattice and calculates a Mean-Squared Error (MSE) value for a second element of the lattice based on a difference between the second element and the first element. In at least some embodiments, the receiver selects the first element to be a base element and calculates subsequent MSE values for elements of the lattice based on a difference between each element and the base element.

In at least some embodiments, an electronic device comprises a processor and a receiver coupled to the processor. The receiver has a Mean-Squared Error (MSE) calculator that reduces multiplications by recursively re-using a value associated with a base element of a lattice for subsequent MSE calculations involving elements of the lattice.

In at least some embodiments, a method comprises identifying a relationship between a base element of a lattice and non-base elements of the lattice. The method further comprises using the relationship to calculate Mean-Squared Error (MSE) values for non-base elements of the lattice.

### BRIEF DESCRIPTION OF THE DRAWINGS

For a detailed description of various embodiments of the invention, reference will now be made to the accompanying drawings in which:

FIG. 1 illustrates a lattice-based list in accordance with embodiments of the disclosure;

FIG. 2 illustrates a linear transformation on a lattice in accordance with embodiments of the disclosure;

FIG. 3 illustrates an Minimum Mean-Squared Error (MMSE) Lattice-Reduction-Aided (LR-aided) Multiple-Input Multiple-Output (MIMO) detector in accordance with embodiments of the disclosure;

FIG. 4 shows a block diagram of a receiver in accordance with embodiments of the disclosure;

FIG. 5 illustrates a wireless communication system in accordance with embodiments of the disclosure;

FIG. 6 illustrates an electronic device in accordance with embodiments of the disclosure; and

FIG. 7 illustrates a method in accordance with embodiments of the disclosure.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection

### DETAILED DESCRIPTION

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

Embodiments of the disclosure efficiently calculate mean-squared error (MSE) values. In at least some embodiments, MSE values are efficiently calculated for elements of a lattice by selecting a “base” element and then relating each “non-base” element to the base element. In other words, MSE calculations for the non-base elements can be simplified by identifying a relationship between the base element and each non-base element and by recursively applying part of the MSE calculation for the base element to the MSE calculations of the non-base elements.

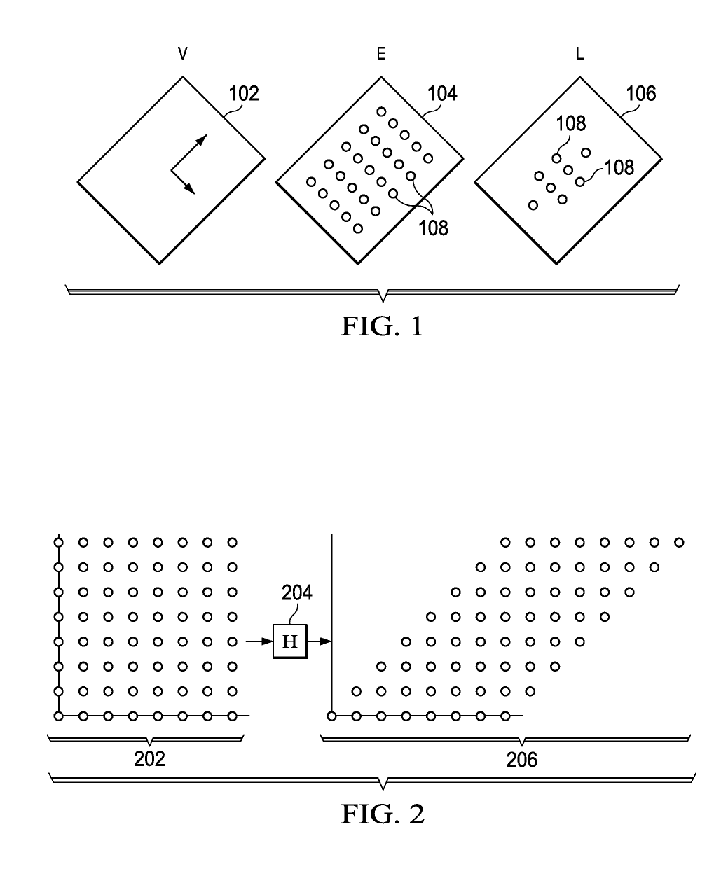

FIG. 1 illustrates an integer lattice-based list in accordance with embodiments of the disclosure. In FIG. 1, a definition of an integer lattice is provided as well as a description of how a linear transformation affects a geometric shape. An integer lattice in the real vector space Rⁿ is a discrete subgroup of the space Rⁿ spanning the real vector space Rⁿ. Integer lattices in Rⁿ can be generated from a basis for the space by creating all linear combinations of the basis with integer coefficients, where the lattice elements are regularly spaced. In FIG. 1, V 102 represents V=[v₁ v₂] and is the basis used to generate an integer lattice E 104 having elements 108. The integer lattice E 104 represents E={m v̅₁+n v̅₂|m=±1, ±2, . . . , ±c; n=±1, ±2, . . . , ±c} and is the linear combination of basis vectors v₁ and v₂ for integer coefficients −2, −1, 0, 1, and 2. The list L 106 represents L⊂E, c=2 and is a subset of the integer lattice E 104, where c=2. In at least some embodiments, determining a list such as L involves calculating MSE values for elements of a lattice as described herein. Although the embodiments described herein involve an integer lattice, alternative embodiments may involve a floating point lattice, which requires higher complexity to process.

FIG. 2 illustrates a linear transformation on a lattice in accordance with embodiments of the disclosure. The transformation shown in FIG. 2 is illustrated in two dimensions, but the same concept extends to higher dimensions as well. In FIG. 2, a square lattice 202 is passed though a matrix H 204 (i.e., by multiplication). The matrix multiplication is nothing more than a linear transformation and is, geometrically, just a stretching and squeezing of one shape into another.

As shown, the stretching and squeezing of the square lattice 202 results in a parallelogram lattice 206. Similarly, in two dimensions a linear transformation on a circle produces an ellipse. The same concept extends to higher dimensions. For example, in three dimensions a sphere becomes an ellipsoid. In dimensions four and above, a hypersphere becomes a hyperellipsoid. Also, in dimensions four and above, a hyperparallelopiped becomes another hyperparallelopiped even though the two objects are transformations of one another.

In a communication system, various lattice shapes such as those described herein can be used to represent transmitted data. When using linear transformations in a communication system, a typical operation is an equalization step. For example, a zero forcing equalizer takes the channel matrix H and inverts it in order to perform detection. Other equalizers include the Minimum Mean-Squared Error (MMSE) equalizer and successive interference cancellation. Additionally, all of these equalizers can be combined with other processing such as lattice-reduction (LR) in order to perform detection. In the context of lattice-reduction, efficiently enumerating MSE values over a lattice is particularly useful.

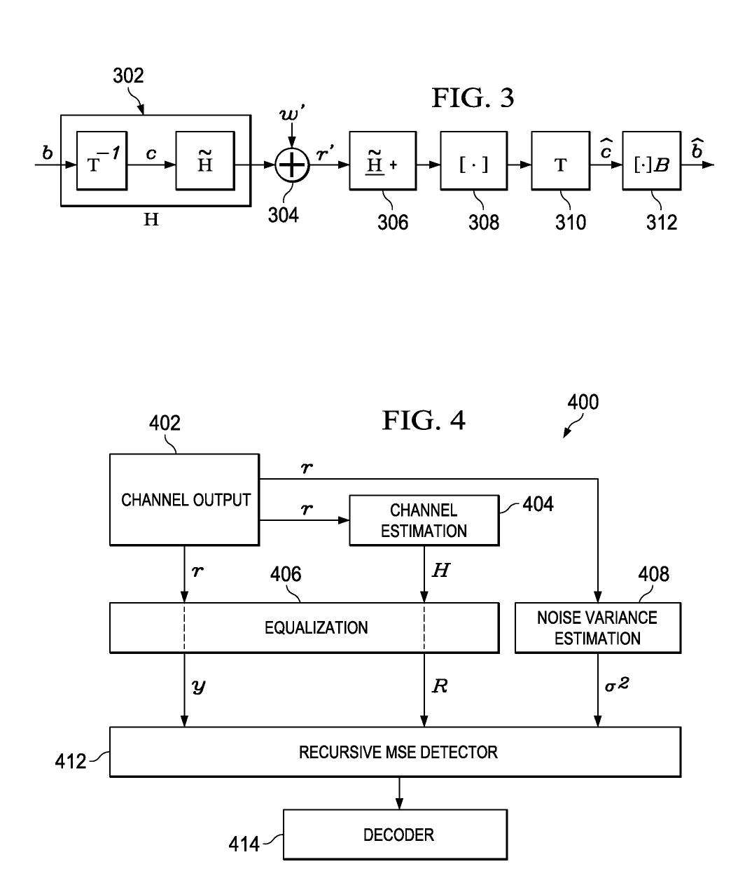

FIG. 3 illustrates a MMSE LR-aided Multiple-Input Multiple-Output (MIMO) detector 300 in accordance with embodiments of the disclosure. In alternative embodiments, a Soft Interference Cancellation (SIC) LR MIMO detector or a zero-forcing (ZF) LR MIMO detector may utilize the efficient MSE calculations described herein.

An LR-aided detector such as detector 300 operates in three steps. First, the detector 300 performs lattice reduction to find a reduced basis \tilde{H}=HT in block 302. As used herein, T refers to a unimodular matrix having integer entries, where the absolute value of T's determinant is 1. Second, the detector 300 adapts the viewpoint r′=\tilde{H}c+ω′ by adding the output of block 302 with ω′ (using adder 304) and implements a low-complexity MIMO detector (e.g., a linear or decision-feedback detector) to recover c. As used herein, c refers to a shifted and scaled version of the channel input. In FIG. 3, blocks 306, 308 and 310 represent a technique for estimating c as

$${\hat{c}}_{LR - MMSE} = [ {\underline{\tilde{H}}}^{+} {\underline{r}}^{′} ] , \\ where$$

$$\tilde{\underline{H}} = [ \begin{matrix}H \\ σ I\end{matrix} ] T , \\ {\underline{r}}^{′} = {[ {r}^{T} , 0 ]}^{T}$$

and [•] denotes a component-wise rounding to integers. In at least some embodiments, estimating ĉ involves calculating MSE values for elements of a lattice as described herein. Third, the detector 300 recovers the inputs to the original channel using the relationship b=Tc in block 312. In FIG. 3, b is estimated as \hat{b}=[Tĉ]_{B}, where [•]_{B} denotes a component-wise rounding to the nearest element of B.

Lattice reduction can be described as the process of transforming a basis H into a new (reduced) basis \tilde{H}=HT that is as orthogonal as possible. One property of lattice-reduction-aided (LR-aided) detection is that after linear transformation by the matrix T the noise is effectively whitened (i.e., the noise affects all elements of a lattice in a similar manner). This property can be exploited to simplify MSE calculations.

An MSE calculation can be expressed mathematically as ∥r−Ha∥², where r and a are vectors, H is a matrix, and the operation ∥ x̅∥² is defined as the inner product x̅· x̅. In a typical communications system the choice of a comes from a lattice which is transformed by the linear transformation H. Furthermore, r is equal to Ha+n where n can be understood to represent noise. Because a is an element of a lattice, MSE values can be efficiently computed when a set of candidates is used.

For example, consider the case of two vectors a₁ and a₂ for which MSE values are to be computed. Assuming the MSE value for a₁ has already been enumerated, the MSE value for a₂ can efficiently be computed using part of the MSE calculation for a₁. The MSE of these two terms can be expressed as MSE₁ and MSE₂ respectively where MSE₁=∥r−Ha₁∥² and MSE₂=∥r−Ha₂∥². In order to reduce complexity, the equality or identity a₂=a₁+Δ can be exploited, where Δ can be determined using the standard orthogonal unit basis vectors. In two dimensions these vectors are [0 1]^{T} and [1 0]^{T}, where the superscript ^{T} denotes the vector transpose operation. MSE₂ can therefore be written as MSE₂=∥r−H(a₁+Δ)∥²=∥r−Ha₁−HΔ∥². Because the quantity (r−Ha₁) was already determined for MSE₁, this value can be re-used for the MSE₂ calculation.

Furthermore, HΔ is not a matrix multiplication, but rather a summing of the columns of H with coefficients corresponding to a lattice from which the candidates a₁ and a₂ are drawn. Specifically, in two dimensions the operation

$$H [ \begin{matrix}1 \\ 0\end{matrix} ]$$

selects the first column of H and the operation

$$H [ \begin{matrix}0 \\ 1\end{matrix} ]$$

selects the 2^{nd} column. As an example, if

$$Δ = [ \begin{matrix}5 \\ 4\end{matrix} ] ,$$

then the HΔ vector can be decomposed into two terms where the first term is

$$5 [ \begin{matrix}1 \\ 0\end{matrix} ]$$

and the second term is

$$4 [ \begin{matrix}0 \\ 1\end{matrix} ] .$$

Thus, the expression for HΔ can be written as

$$H Δ = 5 ( H [ \begin{matrix}1 \\ 0\end{matrix} ] ) + 4 ( H [ \begin{matrix}0 \\ 1\end{matrix} ] ) ,$$

where

$$H [ \begin{matrix}1 \\ 0\end{matrix} ]$$

$$and$$

$$H [ \begin{matrix}0 \\ 1\end{matrix} ]$$

only need to be determined once per list of candidates.

Returning to the example using a₁ and a₂, one can now see that the term r−Ha₁−HΔ is just a vector addition. The simplification described herein not only reduces the complexity of the MSE calculation for a₂, but actually reduces the complexity of MSE calculations for any other candidate in the same lattice as a₁. Thus, the simplification process described for a₁ and a₂, can be generalized for a_{base} and a_{non-base}. For the generalized example, a new set of equations can be used (i.e., a_{non-base}=a_{base}+Δ and MSE_{non-base}=∥r−H(a_{base}+Δ)|²=∥r−Ha_{base}−HΔ∥²), where the value of Δ changes for different non-base elements.

In at least some embodiments, a_{base} can be changed over time. For example, if the value of Δ increases to more than a threshold value (e.g., [10 10]T), a new a_{base} can be selected so that the value of Δ in the equation a_{non-base}=a_{base}+Δ is again small (e.g., [1 2]T). In cases where the value of the new a_{base} has already been calculated (as a non-base element), a matrix multiplication would not even be needed. Thus, a_{base} can be changes multiple times during the detection process.

In at least some embodiments, the zero vector of the lattice is selected as the base element. In such case, multiplying H by the zero vector always results in the zero vector. Alternatively, the base element may be the first non-zero lattice element that is inside a lattice boundary. Alternatively, any element of a lattice can be selected as the base element. Although described for two-dimensional lattices, the efficient calculation of MSE values in a lattice can extend to higher dimensions as well (greater than two). To complete each MSE calculation, a circuit that computes the norm squared of a quantity is employed. The circuit should work for any vector input where the input is the term r−Ha_{base}−HΔ and the output is the norm squared of the quantity ∥r−Ha_{base}−HΔ∥².

FIG. 4 shows a block diagram of a receiver 400 in accordance with embodiments of the disclosure. In FIG. 4, the channel output block 402 represents an incoming signal from a channel (e.g., a MIMO channel). In some embodiments, the channel output (r) is provided to a channel estimation block 404, which estimates the MIMO channel and outputs the channel matrix H. In other embodiments, the channel matrix H may have been estimated previously by other means and stored. The channel output r is also provided to a noise-variance estimation block 408, which estimates the noise variance (\hat{σ}²) of the channel output r. As shown, an equalization block 406 equalizes the channel output 7, and the channel matrix H yielding the equalized channel output y and the equalized channel matrix R. Subsequently, values for y, R and \hat{σ}² are provided to a recursive MSE detector block 412, which calculates MSE values using the simplification and norm calculation discussed previously as part of the detection process. The output of the recursive MSE detector 412 is provided to a decoder 414, which decodes the received signal. The recursive MSE detection process can advantageously reduce the computational burden of the receiver 400 by reducing the number of multiplications required. In some embodiments, the recursive MSE operation can be used for equalization as well as detection. The blocks of FIG. 4 can be representative of hardware, firmware, and/or software as would be understood by one of skill in the art.

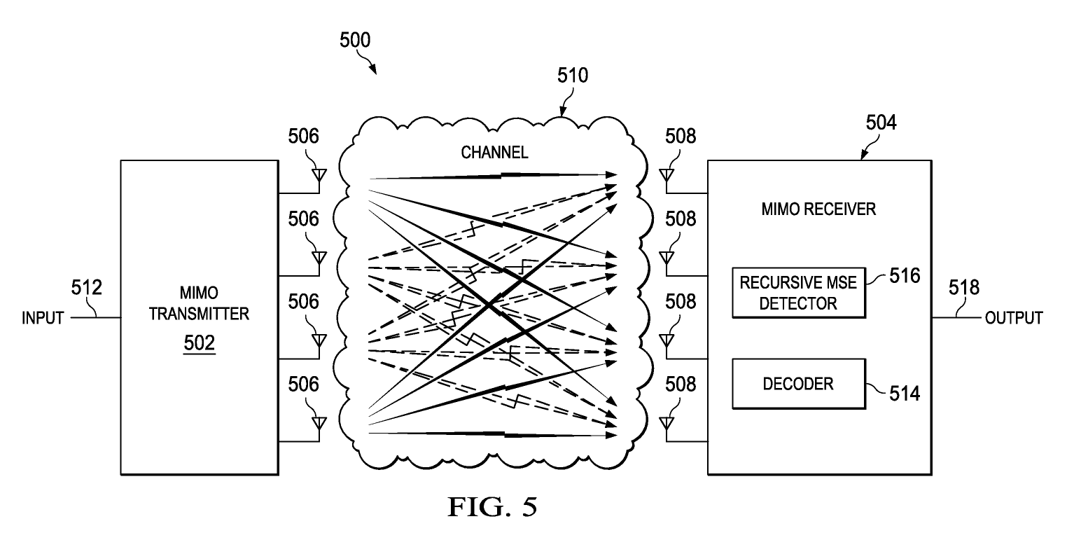

FIG. 5 shows an illustrative embodiment of a wireless communication system 500 in accordance with embodiments of the invention. As shown, the wireless communication system 500 comprises a MIMO transmitter 502 having at least one antenna 506 for transmitting radio frequency signals received as input 512. The MIMO transmitter 502 may represent a fixed or portable wireless device, a cellular phone, a personal digital assistant, a wireless modem card, or any other device configured to transmit on a MIMO wireless network. In FIG. 1, a MIMO receiver 504 is configured to receive radio frequency signals transmitted by the MIMO transmitter 502. The MIMO receiver 504 has at least one antenna 508 for receiving transmitted radio frequency signals.

As shown, the MIMO transmitter 502 transmits radio frequency signals to the MIMO receiver 504 through a channel 510. While MIMO systems may greatly increase spectral efficiency, the process of separating signals simultaneously transmitted from multiple antennas 506 may be burdensome for the MIMO receiver 504. To reduce the computational burden, the MIMO receiver 504 comprises a recursive MSE detector 516, which efficiently computes MSE values for elements of a lattice as described herein. In at least some embodiments, the recursive MSE detector 516 comprises an Application-Specific Integrated Circuit (ASIC) that receives inputs such as an equalized channel output and an equalized channel matrix and then outputs a list of candidates based on MSE calculations. In at least some embodiments, the recursive MSE detector 516 selects a “base” element of a lattice (the lattice represents the received inputs) and then identifies a relationship between each non-base element of the lattice and the base element of the lattice as previously described. The MSE calculations for the non-base elements can be simplified by recursively applying the MSE calculation performed for the base element to the MSE calculations for the non-base elements. After decoding a signal, the MIMO receiver 504 can provide an output 518, which includes the decoded signal.

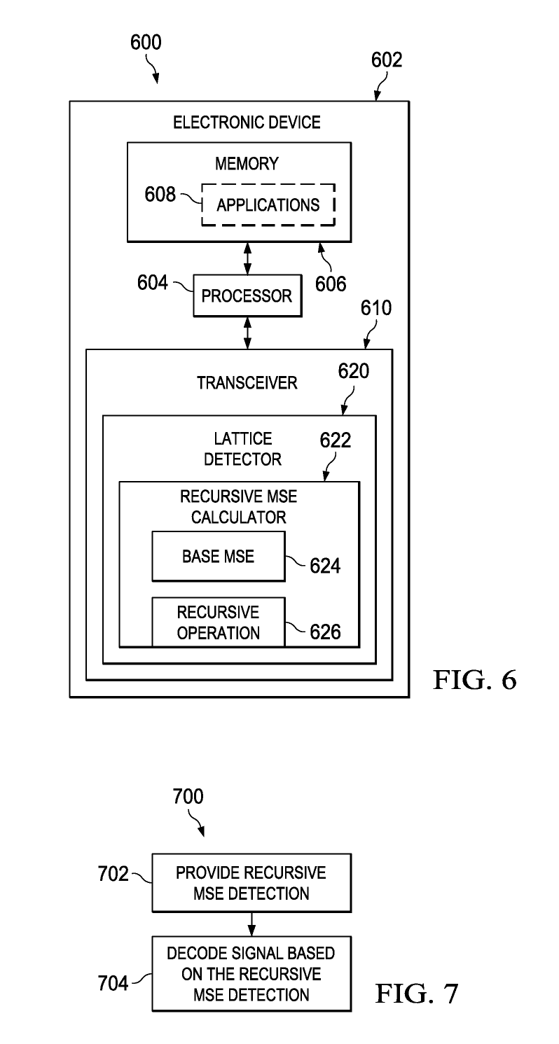

FIG. 6 illustrates an electronic device 602 in accordance with embodiments of the disclosure. Electronic devices such as the device 602 communicate wirelessly (or via a wired connection) using a variety of techniques to prepare, send, receive, and recover data. For example, data preparation techniques may include data scrambling, error correction coding, interleaving, data packet formatting, and/or other techniques. The data to be transmitted is converted into blocks of data (i.e., bits) transmitted as information symbols. Each information symbol is associated with a constellation of complex amplitudes.

If data communication is wireless, the electronic device 602 may employ one or more antennas to “pick up” wireless signals, after which data is recovered by sampling the received signal and decoding each information symbol. To recover data, the electronic device 602 may implement techniques such as signal amplification, digitization, sample rate conversion, data correlation, equalization, demodulation, de-interleaving, de-coding, and/or de-scrambling.

The electronic device 602 may represent any of a variety of devices such as a server, a desktop computer, a laptop computer, a cellular phone, a Personal Digital Assistant (PDA), a smart phone or other electronic devices. In various embodiments, the electronic device 602 receives communications based on an 802.11(a), (g), or (n) protocol, a Worldwide Interoperability of Microwave Access (WiMAX) protocol, an Ultra Wideband (UWB) protocol, a Long-Term Evolution (LTE) protocol or some other communication protocol now known or later developed.

As shown, the electronic device 602 comprises a processor 604 coupled to a memory 606 and a transceiver 610. The memory 606 stores applications 608 for execution by the processor 604. The applications 608 could comprise any known or future application useful for individuals or organizations. As an example, such applications 608 could be categorized as operating systems, device drivers, databases, presentation tools, emailers, file browsers, firewalls, instant messaging, finance tools, games, word processors or other categories. Regardless of the exact nature of the applications 608, at least some of the applications 608 may rely on signals received via the transceiver 610.

To more efficiently process received signals, the transceiver 610 employs a lattice detector 620 having a recursive MSE calculator 622. The recursive MSE calculator 622 includes a base MSE component 624, a recursive operation component 626. In at least some embodiments, the base MSE component 624 selects a “base” element and then relates each “non-base” element to the base element for MSE calculations. In other words, the base MSE component 624 determines the value of Δ in the comparison a_{non-base}=a_{base}+Δ, where the value of Δ changes for different non-base elements. The base element may be the zero vector or some other vector of a lattice. Additionally or alternatively, the base MSE component 624 computes an MSE value for a base element (i.e., ∥r−Ha_{base}∥²) and stores the resulting value as MSE_{base}.

The recursive operation component 626 performs a recursive operation for different elements of a lattice (e.g., elements i=2 to L). For each element involved, the recursive operation component 626 computes HΔ, subtracts the value MSE_{base} from HΔ, and performs the norm-squared operation to determine ∥r−Ha_{base}−HΔ∥². The components of the MSE calculator 622 can be representative of hardware, firmware, and/or software as would be understood by one of skill in the art.

FIG. 7 illustrates a method 700 in accordance with embodiments of the disclosure. The method 700 comprises providing recursive MSE detection (block 702). At block 704, a signal is decoded based on the recursive MSE detection. In at least some embodiments, the recursive MSE detection involves selecting a “base” element of a lattice and then relating each “non-base” element of the lattice to the base element for MSE calculations (i.e., a_{non-base}=a_{base}+Δ, where the value of Δ changes for different non-base elements). The recursive MSE detection also involves computing or receiving the value MSE_{base}=∥r−Ha_{base}∥². The value for MSE_{base} may be stored and applied during the recursive operation to determine the value ∥r−Ha_{base}−HΔ∥² for each non-base element.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A wireless communication system, comprising:
a transmitter that transmits a Multiple-Input Multiple-Output (MIMO) signal over a communication channel; and
a receiver that receives the MIMO signal as an output of the communication channel,
wherein the receiver selects a first element of a lattice and calculates a Mean-Squared Error (MSE) value for a second element of the lattice based on a difference between the second element and the first element.

2. The wireless communication system of claim 1 wherein the receiver selects the first element to be a base element and calculates an MSE value for each element of the lattice based on a difference between each element of the lattice and the base element.

3. The wireless communication system of claim 1 wherein the receiver selects the first element to be a base element and calculates a MSE value for each element of a reduced-lattice based on a difference between each element of the reduced-lattice and the base element.

4. The wireless communication system of claim 1 wherein the receiver recursively applies a previously determined MSE value related to the first element when calculating MSE values for other elements of the lattice.

5. The wireless communication system of claim 1 wherein the receiver calculates HA for the second element based on a decomposition technique.

6. The wireless communication system of claim 1 wherein the lattice is two-dimensional.

7. The wireless communication system of claim 1 wherein the lattice is at least three-dimensional.

8. The wireless communication system of claim 1 wherein the receiver implements at least one detector that relies on the calculated MSE value, the at least one detector selected from the group consisting of a Minimum Mean-Squared Error (MMSE) Lattice-Reduction Aided (LR) Multiple-Input Multiple-Output (MIMO) detector, a Soft Interference Cancellation (SIC) LR MIMO detector, and a zero-forcing (ZF) LR MIMO detector.

9. An electronic device, comprising:
a processor; and
a receiver coupled to the processor, wherein the receiver has a Mean-Squared Error (MSE) calculator that reduces multiplications by recursively re-using a value associated with a base element of a lattice for subsequent MSE calculations involving elements of the lattice.

10. The electronic device of claim 9 wherein the MSE calculator is part of a lattice detector.

11. The electronic device of claim 9 wherein MSE calculator identifies a relationship between the base element and other elements of the lattice.

12. The electronic device of claim 11 wherein the relationship is integer-based.

13. The electronic device of claim 9 wherein the MSE calculator identifies a relationship between the base element and other elements of a reduced-lattice.

14. The electronic device of claim 9 wherein MSE calculations for elements of the lattice are part of an equalization process performed by the receiver.

15. A method, comprising:
identifying a relationship between a base element of a lattice and non-base elements of the lattice; and
using the relationship to calculate Mean-Squared Error (MSE) values for non-base elements of the lattice.

16. The method of claim 15 further comprising recursively re-using a value associated with the base element to calculate the MSE values for non-base elements of the lattice.

17. The method of claim 15 further comprising decoding a signal based on the calculated MSE values.

18. The method of claim 15 further comprising equalizing a channel output and a channel estimation based on the calculated MSE values.

19. The method of claim 15 further comprising reducing a size of the lattice before calculating the MSE values.

20. The method of claim 15 further comprising calculating an MSE value for the base element before calculating MSE values for the non-base elements.
